(19) United States
(12) Patent Application Publication
(10) Pub. No.: US 2022/0362719 A1
(43) Pub. Date: Nov. 17, 2022

(54) Filtration Filter And Method For Producing The Same

(71) Applicant: Kabushiki Kaisha F.C.C., Hamamatsu-shi (JP)

(72) Inventors: Masatsugu Ono, Hamamatsu-shi (JP); Makoto Takagi, Hamamatsu-shi (JP)

(21) Appl. No.: 17/843,988

(22) Filed: Jun. 18, 2022

Related U.S. Application Data
(63) Continuation of application No. PCT/JP2021/001099, filed on Jan. 14, 2021.

(30) Foreign Application Priority Data
Jan. 28, 2020 (JP) 2020-011393

(51) Int. Cl. B01D 69/10; B01D 69/02; B01D 61/14; B01D 71/68; B01D 67/00

(52) U.S. Cl. CPC B01D 69/106; B01D 69/02; B01D 61/14; B01D 69/1071; B01D 71/68; B01D 67/0016; B01D 2325/02833; B01D 2325/04

(57) ABSTRACT

A filtration filter for filtering out impurities has a support with a fibrous structure. A filtration membrane is integrally formed inside the support. The filtration membrane includes a porous resin and is capable of filtering out impurities. The filtration membrane includes a porous resin membrane having an average pore size of 0.026 μm and an opening ratio of 6% to 30%.

### CROSS-REFERENCE TO RELATED APPLICATIONS

This application is a continuation of International Application No. PCT/JP2021/001099, filed Jan. 14, 2021, which claims priority to Japanese Application No. 2020-011393, filed Jan. 28, 2020. The disclosures of the above applications are incorporating herein by reference.

### FIELD

The present disclosure relates to a filtration filter and a method for producing a filtration filter for filtering out impurities.

### BACKGROUND

For example, a microfiltration membrane, an ultrafiltration membrane, and the like are used for water treatments performed in water purification plants. A reverse osmosis membrane and the like are used in water treatments for seawater desalination. Examples of a filtration filter that includes a microfiltration membrane or an ultrafiltration membrane include a filtration filter produced by uniformly applying a resin solution onto the surface of a support composed of PET nonwoven fabric or the like with a bar coater or the like. The support is immersed in a nonsolvent liquid, such as water, in order to replace the solvent of the resin solution with the nonsolvent liquid by phase separation (NIPS process) and thereby form a porous resin on the surface of the support. An ultrafiltration membrane that includes a support and a porous resin, dense porous skin layer portion, disposed on the surface of the support is disclosed in, for example, Japanese Unexamined Patent Application Publication No. H9-299772

In the above related art, since a porous resin is formed on the surface of a support, it may be difficult to firmly and consistently hold the porous resin on the support. Furthermore, in the filtration filter known in the related art, since it is difficult to increase the number of openings (opening ratio) of the porous resin while maintaining the size of the openings, it is difficult to increase the amount of permeate while maintaining impurity rejection rate.

### SUMMARY

The present disclosure was made in light of the above circumstances. The present disclosure provides a filtration filter that enables the porous resin to be firmly and consistently held on the support. It increases the amount of permeate while maintaining impurity rejection rate. A method for producing the filtration filter is also disclosed.

According to the disclosure, a filtration filter, capable of filtering out impurities, comprises a support composed of a fibrous structure and a filtration membrane integrally formed inside the support. The filtration membrane includes a porous resin and is capable of filtering out impurities. The filtration membrane includes a porous resin membrane having an average pore size of 0.026 μm and an opening ratio of 6% to 30%.

Further, the filtration filter includes the support with a structure having a thickness of 0.03 to 0.5 mm. The filtration filter filtration membrane includes a porous resin with a thickness of 10 to 500 μm. The filtration filter support includes a structure with chemical fibers. The filtration filter support includes an aramid resin or a polyethylene terephthalate resin. The filtration filter filtration membrane includes polysulfone (PSF), polyvinylidene fluoride (PVDF), polyethersulfone (PES), polyimide (PI), polyvinyl chloride (PVC), or cellulose acetate (CA).

According to a second aspect of the disclosure, a method for producing a filtration filter for filtering out impurities, comprises impregnating a support composed of a fibrous structure with a resin solution prepared by dissolving a predetermined resin in a predetermined solvent. The support is immersed in a nonsolvent liquid in order to cause a phase separation phenomenon where the solvent included in the resin solution is replaced with the nonsolvent liquid. This integrally forms a filtration membrane inside the support. The filtration membrane includes a porous resin and is capable of filtering out impurities.

The method for producing a filtration filter where the filtration membrane includes a porous resin membrane having an opening ratio of 6% to 30%. The method for producing a filtration filter where the support includes a structure with a thickness of 0.03 to 0.5 mm. The method for producing a filtration filter where the filtration membrane includes a porous resin with a thickness of 10 to 500 μm. The method for producing a filtration where the support includes a structure with chemical fibers. The method for producing a filtration filter where the support includes an aramid resin or a polyethylene terephthalate resin. The method for producing a filtration filter where the filtration membrane includes polysulfone (PSF), polyvinylidene fluoride (PVDF), polyethersulfone (PES), polyimide (PI), polyvinyl chloride (PVC), or cellulose acetate (CA).

According to the present disclosure, the porous resin can be firmly and consistently held on the support. Furthermore, the amount of permeate can be increased while impurity rejection rate is maintained.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for producing a filtration filter.

FIG. 2 is a schematic view of a step for producing the filtration filter.

FIG. 3 is a schematic view of a step for producing the filtration filter.

FIG. 4 is a schematic view of a step for producing the filtration filter.

FIG. 5 is a schematic view of a filtration filter produced by the production method according to the embodiment.

FIG. 6 is a schematic view of a filtration filter of a comparative example produced by a production method known in the related art.

FIG. 7 is a table that lists the amount of permeate and rejection rate measured in each Example and Comparative Example.

FIG. 8 is a micrograph view of the inside structure of the filtration filter according to the embodiment.

FIG. 9(a) is a micrograph view of openings formed in the filtration filter.

FIG. 9(b) is a binary diagram of the micrograph.

FIG. 10(a) is a micrograph view of openings formed in the filtration filter known in the related art.

FIG. 10(b) is a binary diagram of the micrograph.

### DETAILED DESCRIPTION

An embodiment of the present disclosure is specifically described with reference to the drawings.

A filtration filter according to this embodiment is capable of separating and filtering out impurities from water and is a “UF membrane (or MF membrane)” capable of rejecting proteins, viruses, germs, and the like. The filtration filter 5 includes, as illustrated in FIG. 5, a support 1, the inside of which is a fibrous structure, and a filtration membrane M integrally formed inside the support 1. The filtration member M includes a porous resin and is capable of filtering out impurities.

Specifically, the support 1, according to this embodiment, includes a nonwoven fabric or the like that is formed in the shape of a sheet (paper sheet) by a paper-making method (sheet-making method). The inside is a fibrous (net-like) structure. The inside of the fibrous structure is impregnated with a porous resin such that they form a single piece. The support 1, according to this embodiment, includes an aramid resin with openings having a maximum pore size of about 270 μm. In this embodiment, in particular, the opening ratio is set to 6% to 30%.

An aramid resin (aromatic polyamide) includes a plastic that has excellent heat resistance and a high mechanical strength. For example, in the case where the porous resin includes polysulfone (PSF), hydrogen bonds are formed and is hydrophobic, which provides increased adherence (affinity). In contrast, in the case where the support 1 includes a PET resin (polyethylene terephthalate resin), pulp, or the like, hydrogen bonds are not formed between the support 1 and the porous resin, which includes polysulfone (PSF).

The filtration filter 5, according to this embodiment, preferably includes a filtration membrane M that includes a porous resin and has an opening ratio of 6% to 30% and/or a thickness of 10 to 500 μm and a support 1 that has a thickness of 0.03 to 0.5 mm and/or includes a structure including chemical fibers. It is preferable that the support 1, according to this embodiment, includes an aramid resin or a polyethylene terephthalate resin and the filtration membrane M include polysulfone (PSF), polyvinylidene fluoride (PVDF), polyethersulfone (PES), polyimide (PI), polyvinyl chloride (PVC), or cellulose acetate (CA).

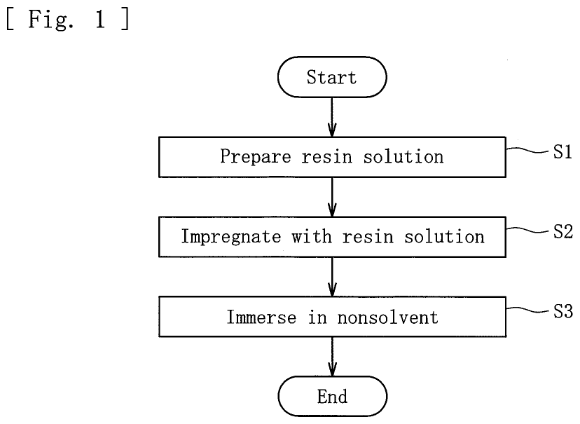

A method for producing the filtration filter according to this embodiment is described with the flowchart illustrated in FIG. 1.

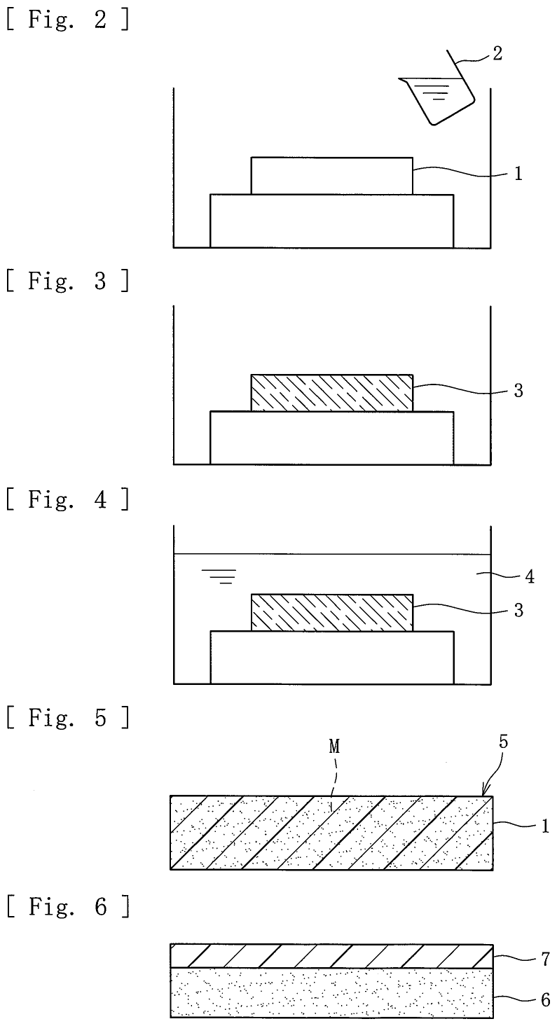

Polysulfone is dissolved in methyl formamide to prepare a resin solution 2 (polymer solution)(S1). As illustrated in FIGS. 2 and 3, a support 1 is prepared by forming aramid fiber pulp in the shape of a paper sheet by a paper-making method. It is impregnated with the resin solution 2 to prepare a resin-impregnated body 3.

After the excess solution that remains on the surface has been removed with a bar coater, the resin-impregnated body 3 is immersed in a nonsolvent 4 (in this embodiment, water) as illustrated in FIG. 4 (S3). This causes a phase separation phenomenon where the solvent of the resin solution 2 is replaced with the nonsolvent 4 (water). Consequently, the filtration filter 5 includes a filtration membrane M integrally formed inside the support 1 with a porous resin and is capable of filtering out impurities, as can be formed as illustrated in FIGS. 5 and 8.

Specifically, the above-described membrane production method where a phase separation phenomenon is used is referred to as “NIPS process”. As a result of the solvent of the resin solution 2 being replaced with the nonsolvent 4 (water) by a phase separation phenomenon and the resin being solidified, the resin portion forms a filtration membrane M and the solvent portions replaced with water serve as pores (openings) of the filtration membrane M. The filtration filter 5 produced in the above-described manner includes a support 1 with aramid fibers and a filtration membrane M, with polysulfone, and it is used as an ultrafiltration membrane (UF membrane).

In a filtration filter 5 produced in the above-described manner, the support 1 had a thickness of 0.15 mm. The filtration filter 5 had a total thickness of 0.30 mm, an average pore size of 0.026 μm, and an opening ratio of 9.0%. The term “opening ratio”, used herein, refers to the proportion of the area of the pore portions per unit area. The higher the opening ratio, the larger the amount of permeate. The term “amount of permeate”, used herein, refers to the amount of water that passes through the membrane per unit area, pressure, and time.

The filtration filter 5 produced in the above-described manner was used as Example and compared with Comparative Example. Comparative Example was a filtration filter that included a support 6 composed of PET (polyethylene terephthalate) fibers and a resin membrane 7 that was integrally formed on the surface of the support 6 and composed of polysulfone as illustrated in FIG. 6. The support 6 had a thickness of 0.1 mm. This filtration filter had a total thickness of 0.15 mm, an average pore size of 0.025 μm, and an opening ratio of 3.4%.

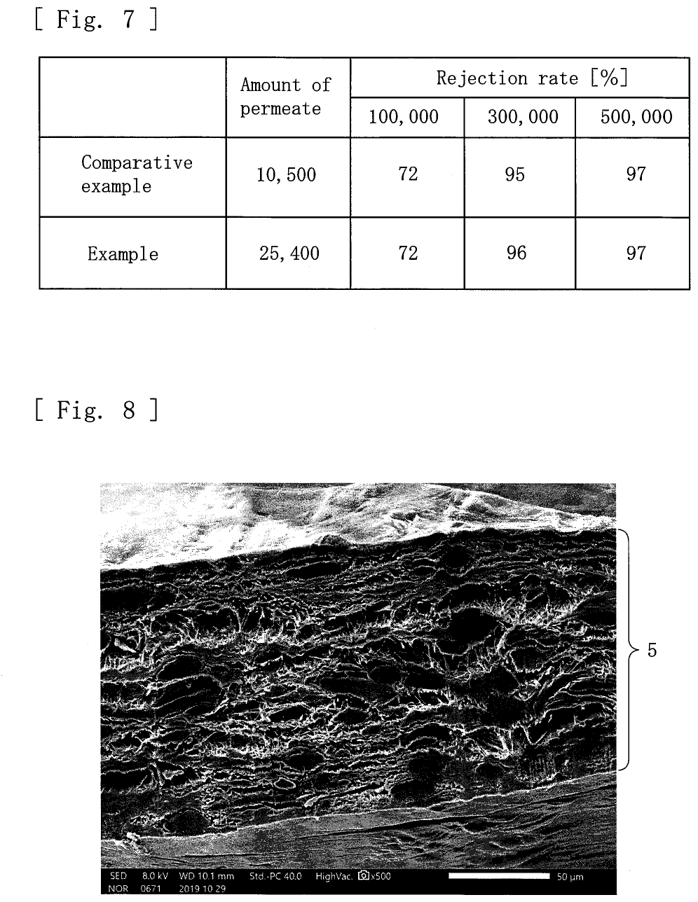

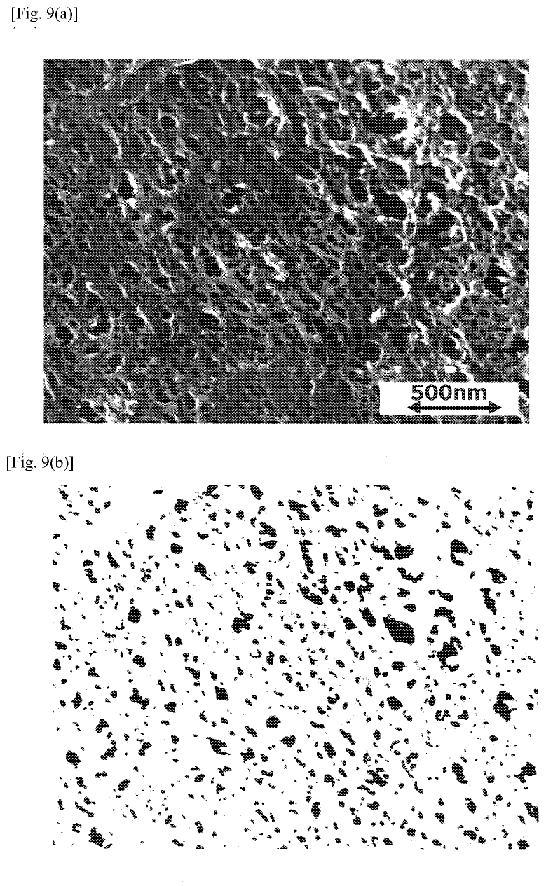

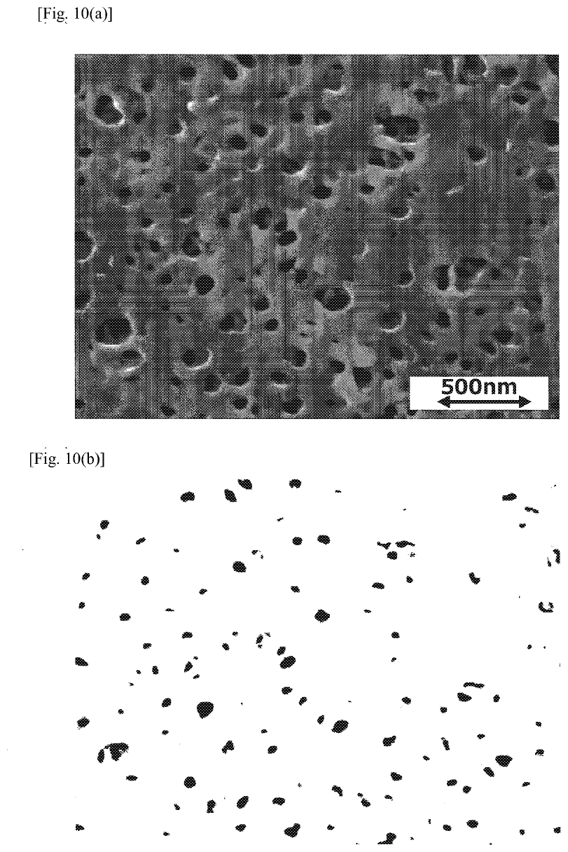

Specifically, although the average pore sizes of Example and Comparative Example were substantially the same, as illustrated in FIG. 9, Example had a larger number of openings than Comparative Example, that is, Example had a higher opening ratio than Comparative Example. On the other hand, as illustrated in FIG. 10, Comparative Example had a smaller number of openings than Example, that is, Comparative Example had a lower opening ratio than Example. FIG. 7 illustrates the test results of comparisons in impurity rejection rate (%) and the amount of permeate (L/(hour·m²·MPa) between Example and Comparative Example.

Note that the impurity rejection rate is determined by passing water containing PEG (reference material) having a predetermined molecular weight (100,000, 300,000, or 500,000) through the filtration membrane (resin membrane) and making a calculation using the following arithmetic expression: (Carbon content in raw water-Carbon content in permeate)/Carbon content in raw water. In this test, the concentration of the reference material (PEG concentration) is set to 2,000 ppm, the pressure (MPa) is set to 0.2, and the circulation time (min) is set to 10.

The test results show that, while the impurity rejection rate does not change greatly in either case, where water containing PEG having a molecular weight of 100,000, 300,000, or 500,000 is used, the amount of permeate measured in Example is about two or more times that measured in Comparative Example and is markedly large. This is presumably because the opening ratio (9.0%) of Example is higher than the opening ratio (3.4%) of Comparative Example. The opening ratio can be determined by capturing a SEM image of the surface of the filtration filter at, for example, a 5,000 to 20,000-fold magnification and analyzing the image with image-processing software. The opening ratio may be determined by, for example, separating the opening portions from the other portions by binarization as illustrated in FIGS. 9(b) and 10(b).

That is, the opening ratio of the filtration membrane (resin membrane) varies depending on the proportion of the resin portion and can be readily adjusted by changing the resin concentration. The pore size of the openings varies depending on the rate of the phase separation and the rate at which the solvent is replaced with the nonsolvent and can be readily adjusted by changing the viscosity of the resin and the type and purity of the nonsolvent. Therefore, setting the above factors and conditions appropriately enables a filtration membrane with a high opening ratio to be produced while maintaining (without increasing) the pore size of the openings as in Example.

Thus, according to this embodiment, the porous resin can be firmly and consistently held on the support 1. In addition, the amount of permeate can be increased while the impurity rejection rate is maintained. Furthermore, in Example, since a fibrous structure (porous structure), such as an aramid resin, is used as a support and the support is impregnated with a resin solution and then immersed in a nonsolvent liquid, in order to perform the phase replacement, the surface roughness of the fibrous structure is high and the surface tension increases the area of contact between the solvent of the resin solution and the nonsolvent liquid. As a result, the rate at which the solvent is replaced with the nonsolvent can be increased.

Moreover, in Example, since a structure (porous structure) that includes an aramid resin or the like is used as a support and the filtration membrane includes polysulfone (PSF), adhesion to the filtration membrane is good and the occurrence of cracking and the like is reduced compared with the case where PET fibers, pulp, or the like is used as a support. Note that PET fibers or pulp may be used as a support when the occurrence of cracking and the like can be reduced.

In addition, in Comparative Example, if wrinkles are present in the support before the filtration membrane is formed on the support, the thickness of the filtration membrane is reduced at the protruded portions of the wrinkles. Also, the thickness of the filtration membrane is increased at the recessed portions of the wrinkles. This results in unevenness in the thickness of the membrane. Furthermore, if large wrinkles are present, the support may be exposed and, consequently, the impurity filtration effect may become degraded. Therefore, in Comparative Example, it is necessary to cut both ends of the support, where wrinkles are likely to occur. In contrast, in Example, even when wrinkles are present in the support, the filtration membrane can be formed inside the support in a suitable manner. Moreover, the structure can be flexibly changed.

The test results of ease of detachment of Example and Comparative Example are described below.

A tape (No. 3800K) produced by Nitto Denko CS System Corporation was put on the surface (membrane surface) of each of Example and Comparative Example. Each tape was rubbed three times by finger. Subsequently, while an end of the tape was held, the end of the tape was slowly pulled such that the tape was bent 180°. The region 25 mm behind the tape was considered as an effective area and the detachment of the filtration membrane (resin membrane) was observed. While detachment occurred at 100% in Comparative Example, detachment occurred at less than 100% (about 50%) in Example.

The above is the description of this embodiment. The present disclosure is not limited to this. For example, the support or the filtration membrane may include another material. The thickness of the above members and the total thickness may be set appropriately. Although the inside of the support is entirely impregnated with the filtration membrane such that they are formed as a single piece in the filtration filter, according to this embodiment, only a part of the support may be impregnated with the filtration membrane such that they are formed as a single piece.

Although, in this embodiment, the filtration filter is applied to an ultrafiltration membrane (UF membrane), the filtration filter may be applied to another filtration membrane, such as an MF membrane. Although the filtration membrane is formed by the NIPS process, where the solvent of the resin solution is replaced with a nonsolvent, in the method for producing the filtration filter, according to this embodiment, the filtration membrane may be formed by another method.

The present disclosure is also applicable to those having another structure or that are produced by another production method, as long as it is a filtration filter with a support including a fibrous structure and a filtration membrane integrally formed inside the support. The filtration membrane includes a porous resin and is capable of filtering out impurities and a method for producing the filtration filter.

What is claimed:

1. A filtration filter for filtering out impurities, the filtration filter comprising:
a support with a fibrous structure; and
a filtration membrane integrally formed inside the support, the filtration membrane includes a porous resin and is capable of filtering out impurities, the filtration membrane includes a porous resin membrane having an average pore size of 0.026 μm and an opening ratio of 6% to 30%.

2. The filtration filter according to claim 1, wherein the support includes a structure having a thickness of 0.03 to 0.5 mm.

3. The filtration filter according to claim 1, wherein the filtration membrane includes a porous resin having a thickness of 10 to 500 μm.

4. The filtration filter according to claim 1, wherein the support includes a structure including chemical fibers.

5. The filtration filter according to claim 4, wherein the support includes an aramid resin or a polyethylene terephthalate resin.

6. The filtration filter according to claim 1, wherein the filtration membrane includes polysulfone (PSF), polyvinylidene fluoride (PVDF), polyethersulfone (PES), polyimide (PI), polyvinyl chloride (PVC), or cellulose acetate (CA).

7. A method for producing a filtration filter for filtering out impurities, the method comprising:
impregnating a support including a fibrous structure with a resin solution prepared by dissolving a predetermined resin in a predetermined solvent;
immersing the support in a nonsolvent liquid in order to cause a phase separation phenomenon;
replacing the solvent included in the resin solution with the nonsolvent liquid; and
integrally forming a filtration membrane inside the support, the filtration membrane including a porous resin and is capable of filtering out impurities.

8. The method for producing a filtration filter according to claim 7, wherein the filtration membrane includes a porous resin membrane having an opening ratio of 6% to 30%.

9. The method for producing a filtration filter according to claim 8, wherein the support includes a structure having a thickness of 0.03 to 0.5 mm.

10. The method for producing a filtration filter according to claim 8, wherein the filtration membrane includes a porous resin having a thickness of 10 to 500 μm.

11. The method for producing a filtration filter according to claim 8, wherein the support includes a structure including chemical fibers.

12. The method for producing a filtration filter according to claim 11, wherein the support includes an aramid resin or a polyethylene terephthalate resin.

13. The method for producing a filtration filter according to claim 8, wherein the filtration membrane includes polysulfone (PSF), polyvinylidene fluoride (PVDF), polyethersulfone (PES), polyimide (PI), polyvinyl chloride (PVC), or cellulose acetate (CA).
